(19) United States
(12) Patent Application Publication
(10) Pub. No.: US 2024/0317110 A1
(43) Pub. Date: Sep. 26, 2024

(54) Vehicle On-Board Electrical System Including A Battery Connection Circuit Having A Converter And Configurably Connectable Load Terminals On Either Side Of The DC-DC Converter

(71) Applicant: Vitesco Technologies GmbH, Regensburg (DE)

(72) Inventors: Markus Dürr, Marloffstein (DE); Mathias Schoierer, Walderbach (DE); Martin Meier, Walderbach (DE)

(73) Assignee: Vitesco Technologies GmbH, Regensburg (DE)

(21) Appl. No.: 18/735,029

(22) Filed: Jun. 5, 2024

Related U.S. Application Data
(63) Continuation of application No. PCT/EP2022/083495, filed on Nov. 28, 2022.

(30) Foreign Application Priority Data
Dec. 9, 2021 (DE) 10 2021 214 089.0

(51) Int. Cl. B60L 58/19; B60K 1/02; B60L 50/60; B60L 53/22; H01M 10/42; H01M 50/51; H01M 50/512; H02J 7/00

(52) U.S. Cl. CPC B60L 58/19; B60K 1/02; B60L 50/60; B60L 53/22; H01M 10/425; H01M 50/51; H01M 50/512; H02J 7/0019; H02J 7/0024; H02J 7/0063; B60L 2210/10; H01M 2010/4271; H01M 2220/20; H02J 2207/20

(57) ABSTRACT

A battery connection circuit is equipped with a first and a second battery terminal, a first and a second load terminal, a configuration circuit and with a DC-DC converter. The DC-DC converter has a first side which is connected to the first battery terminal and a second side which is connected to the second battery terminal. The DC-DC converter is set up to perform DC-DC conversion between the sides. The first load terminal is connected to the first side. The second load terminal is connected to the second side. The configuration circuit is connected to the battery terminals and set up to selectively provide a series state or a parallel state. The configuration circuit selectively connects the battery terminals to one another: in series in the series state, or in parallel in the parallel state. Furthermore, a vehicle on-board electrical system having such a battery connection circuit is described.

### CROSS-REFERENCE TO RELATED APPLICATIONS

This application claims the benefit of PCT Application PCT/EP2022/083495, filed Nov. 28, 2022, which claims priority to German Application 10 2021 214 089.0, filed Dec. 9, 2021. The disclosures of the above applications are incorporated herein by reference.

### TECHNICAL FIELD

The disclosure relates to a vehicle on-board electrical system that includes a battery connection circuit having a converter and configurably connectable load terminals on either side of the dc-dc converter.

### BACKGROUND

Vehicles with electric drive have a high-voltage battery which, by definition, can only deliver a voltage of a particular level. However, there are a number of loads within the vehicle on-board electrical system which sometimes require voltages which differ greatly from the battery voltage, whereas other loads require similar operating voltage levels, however. In particular, a vehicle on-board electrical system having two electric drives can be provided, where each axle is driven by one of these drives. In this case, both drives can be operated with supply voltages which have approximately the same level and so the same energy source is used for both drives.

However, there is then the problem that faults within the connection of the drives to this energy source or faults in the source result in both drives failing. There is a need for a system to be capable of demonstrating a certain redundancy in the supply of power to loads within a vehicle on-board electrical system can be created in order to supply power to at least some of the components or loads in the event of faults in parts of the on-board electrical system.

### SUMMARY

The disclosure provides a battery connection circuit associated with an on-board electrical system.

The disclosure provides a system that equips a battery connection circuit with a DC-DC converter which has two sides (a first side and a second side). A first battery terminal is connected to the first side and a second battery terminal is connected to the second side. In other words, it is proposed to provide a DC-DC converter with two battery terminals, one on either side of the voltage converter. Furthermore, a first and a second load terminal are provided. The first load terminal is provided on the first side of the DC-DC converter or is connected to this terminal and can be connected to the latter directly or indirectly (for instance via a switch). The second load terminal is provided on the second side of the DC-DC converter or is connected to this terminal and can be connected to the latter directly or indirectly (for instance via a switch). In other words, the DC-DC converter is furthermore connected (directly or indirectly) to two load terminals, one on either side, i.e. one load terminal per side in each case. The load terminals are high-voltage terminals and designed for operating voltages >60 V, at least 200 V or at least 400 V or 600 V. This also applies to the battery terminals. The battery terminals are each set up to be connected to a high-voltage battery (i.e. to a nominal voltage as specified previously). The load terminals are each set up to be connected to a high-voltage load (i.e. to a nominal voltage as specified previously). The high-voltage loads can be in the form of pure sinks for electrical energy or in the form of sinks or sources for electrical energy (depending on the operating state).

In order to provide redundancies, inter alia, or else to allow particular operating modes, a configuration circuit is provided. The configuration circuit is connected to the battery terminals. The configuration circuit connects the battery terminals to one another in a configurable manner. In other words, the configuration circuit is connected to both sides of the DC-DC converter. The configuration circuit is set up to selectively provide a series state or a parallel state. In the series state, the battery terminals are connected to one another in series, and in the parallel state they are connected to one another in parallel. These two states are not the only states of the configuration circuit. Rather, the feature according to which the configuration circuit selectively provides a series state or a parallel state is not an exhaustive list of the features or possible states of the configuration circuit. The configuration circuit can in particular additionally have an individual supply state in which the configuration circuit provides no connection between the battery terminals, i.e. does not connect the battery terminals to one another neither in series nor in parallel.

In the parallel state, it is possible for both batteries or voltages present at the battery terminals to be combined with one another without a DC-DC converter to be able to provide energy for at least one of the drives together. This also applies to the series state. For example, if a battery connected to one of the battery terminals only has limited capacity whereas another battery at the other battery terminal is able to provide more, it is thus possible to combine their capacity or else their loads. Depending on the state, it is possible to combine the voltage or the current which are present or impressed at the battery terminals.

Additionally, it is possible for the series state to be established specifically for corresponding charging input voltages, for example for charging with an 800 V DC voltage, in order to thus connect, for example, 400 V batteries, located at the battery terminals, in a series connection so that charging with 800 V is possible. As a result, a high-performance charger is optionally dispensed with for the voltage conversion when using batteries the voltage of which differs from the available charging voltage or when using charging voltages which differ from the battery voltage.

In the parallel state, it is furthermore possible to charge with 400 V without a further voltage conversion so long as the batteries connected to the battery terminals also have an appropriate voltage of approximately the same level. In addition to the energy transfer which can be provided between the battery terminals via the DC-DC converter, the configuration circuit therefore allows additional operating modes which in particular do not burden the DC-DC converter. The DC-DC converter can thus, for example, be provided for a lower power than for the maximum charging power, which means costs can be saved.

In some examples, the configuration circuit is additionally provided for a further state, namely for an individual supply state. In this state, the configuration circuit does not connect the two battery terminals (i.e. the first and the second battery terminal) to one another. In this case, although there is no connection between the battery terminals via the configuration circuit, there is a connection via the DC-DC converter since the latter connects the battery terminals to one another.

The individual supply state can also be provided if a defect is located on one side of the DC-DC converter, for instance in an electrical system branch connected to one of the load terminals or battery terminals, in order to thus prevent the fault therefrom preventing the fault-free operation of unaffected on-board electrical system branches. The individual supply state then serves to isolate parts of the on-board electrical system or of the circuit in order to thus disconnect a section which is affected by faults from the other fault-free sections in order to thus allow the fault-free sections to operate without being influenced by the fault present in the first-mentioned section.

The individual supply state can be realized as a driving state. The individual supply state can then be set if both loads (for example drives) connected to the load terminals are active. During the individual supply state, e.g., in the driving state, the converter can be provided to perform balancing between the two battery terminals, for instance in order to balance states of charge of batteries which are connected to the battery terminals or to provide one battery with a higher state of charge than the other battery in a targeted manner. This balancing of the states of charge is carried out in an individual supply state in which the power which is output at the load terminals is low, for instance if this power is below a predefined threshold. This threshold can denote a power which is below a driving power (e.g. 1% or 5% of the maximum driving power). In other words, the individual supply state can then be set if no driving state prevails in order to thus for instance balance the state of charge in an unloaded manner. For example, the balancing can be performed (in the individual supply state) if no charging power is introduced (or is fed back) from outside. In some examples, the balancing is performed (in the individual supply state) if charging power is introduced, or is fed back, from outside.

In some examples, the mentioned states (series state/parallel state/optionally also individual supply state) are mutually exclusive. If the configuration circuit is in the series state, the parallel state is then ruled out (and for example, also the individual supply state). If the configuration circuit is in the parallel state, the series state is then ruled out (and also the individual supply state). If the individual supply state is provided, the series state and the parallel state are then ruled out. Additionally, the DC-DC converter is inactive in the series state. This also applies to the parallel state. In the individual supply state, the DC-DC converter is active. In this case, active refers to the state in which the DC-DC converter transfers power from the first side to the second side, or vice versa, for the purpose of converting voltage. Conversely thereto, in the individual supply state, the DC-DC converter can be inactive, for instance if the DC-DC converter itself has a fault. The individual supply state can have two sub-states: a first in which the DC-DC converter is active and a second in which the DC-DC converter is inactive. In the active state, the DC-DC converter transfers a voltage from one side to the other side of the DC-DC converter for converting the voltage. In this case, at least one working switch of the DC-DC converter is opened and closed in a clocked manner. In the inactive state, the DC-DC converter transfers no voltage from one side to the other side of the DC-DC converter. In particular, in this case, at least one working switch of the DC-DC converter is permanently open.

As mentioned, the system provides two load terminals which are located on either side of the converter. The load terminals are electric drive terminals, i.e. terminals for an inverter of an electric drive. In addition, at least one load terminal for other types of loads is provided, for example for an electrical heater (in particular having an operating voltage range which at least partially overlaps with an operating voltage range of an inverter) and/or a load terminal for a step-down converter which is set up to produce, from a voltage present on one side of the DC-DC converter, a low voltage, for example at the level of 12 V, 14 V, 24 V, 48 V or generally a voltage below 60 V. The at least one load terminal which is not provided as an electric drive terminal (“load terminal”) may be a terminal in addition to the two mentioned load terminals which are electric drive terminals. More than one load terminal can therefore be located on one side of the converter. This can also apply to both sides of the DC-DC converter.

Some examples of the battery connection circuit allow for the battery terminals to each have poles, such as two poles in the form of a positive pole or of a negative pole. One pole of a battery terminal can be connected directly to an associated pole of an associated side of the DC-DC converter. This can also apply to the other pole of this battery terminal. For this purpose, each side of the DC-DC converter has a positive pole and a negative pole. In some examples, both poles of a battery terminal can each be connected (in a direct manner) directly to the associated pole of the same side of the DC-DC converter. Furthermore, also only one pole of a battery terminal can be connected (in a direct manner) to an associated pole or associated side of the DC-DC converter.

Instead of a direct (switch-free) connection, a connection via a battery switch can be provided. The battery switch may be provided in series between the two ends of the connection. The battery switch is set up to disconnect the connection in the open state and to connect the connection in the closed state. In this case, a battery terminal has one pole which is connected to a connection point via a battery switch. If the other pole is connected directly (switch-free) to the voltage converter, this is then referred to as a single-pole connection. A connection which is switched, i.e. which has a battery switch, is referred to as an indirect connection.

It is also possible for both poles of a battery terminal to each be connected to a respective connection point via a battery switch (“all-pole connection”). Such a connection via a battery switch can also be referred to as an indirect connection. It is therefore possible for both poles of a battery terminal to be connected directly to the associated side of the DC-DC converter, it is possible for both poles of the battery terminal to be connected indirectly to the associated side of the DC-DC converter (where this corresponds to an all-pole connection), or it is possible for one pole of a battery terminal to be connected directly to an associated pole of the associated side of the converter while the other pole of the same battery terminal is connected indirectly (via a battery switch) to a connection point (where this corresponds to a single-pole connection).

In this case, the connection point is in turn connected to an associated pole of an associated side of the DC-DC converter via a disconnecting switch. In the case of an indirect connection, there is therefore a connection to a connection point via a battery switch, where this connection point is in turn connected to the associated pole of the associated side via a disconnecting switch. An indirect connection therefore involves the connection of a pole of a battery terminal to a connection point via a battery switch, which connection point is in turn connected to the associated pole via a disconnecting switch. In contrast thereto, a direct connection of a pole of a battery terminal would be the direct connection (battery-switch-free connection) between this pole and an associated pole of the corresponding side of the DC-DC converter without going via the battery switch and the disconnecting switch.

In other words, a pole of a battery terminal can therefore be connected directly to the associated pole of the DC-DC converter or can be connected to the associated pole of the associated side of the DC-DC converter via a series connection of a battery switch or of a disconnecting switch. In this series connection of battery switch and disconnecting switch, the connection point is provided in the center between the two switches. In some examples, each indirect connection has a connection point. The one or more connection points are connected directly to a pole of a load terminal. The at least one connection point therefore serves for the connection of at least one load terminal. Furthermore, the at least one connection point serves for the connection to one side of the DC-DC converter, where, in this case, the connection point is connected to one side or to one pole of the DC-DC converter via a disconnecting switch. Moreover, a load terminal can be connected via a disconnecting switch to a battery terminal and to one side of the converter without a battery switch being provided (i.e. switch-free).

In some implementations, for the first side of the DC-DC converter to have two poles (negative pole and positive pole) which are each connected directly to the poles of the first battery terminal while the second side of the DC-DC converter has poles of which either both are connected to the second side of the DC-DC converter in each case via a battery switch, a connection point and a disconnecting switch, or one pole of the battery terminal is connected to the associated pole of the second side of the DC-DC converter via a battery switch, a connection point and a disconnecting switch while the other pole of the battery terminal is connected directly (or via a switch) to the relevant pole of the second side of the DC-DC converter. In this case, the first-mentioned pole of the battery terminal which is connected indirectly (via the battery switch, the connection point and the disconnecting switch) to the relevant pole of the second side of the DC-DC converter can be the negative pole and the other switch which is connected directly (or via a switch) can be the positive pole. Other examples provide a comparable connection, where the positive and negative pole are reversed with respect to the aforementioned connection. It is also possible for both sides to provide an indirect connection of the respective battery terminal to the respective side of the DC-DC converter or for battery terminals to be provided on either side of the DC-DC converter which are connected to the respective side of the DC-DC converter by a direct connection.

One pole of one side of the DC-DC converter or both poles can be connected to one of the load terminals via a disconnecting switch. Moreover, one pole of a battery terminal or both poles can be connected to one of the load terminals via a battery switch. As a result, the battery can be cut off, for example, by opening one or both of the battery switches such that power can be supplied via the converter. In the same way, the disconnecting switch can be opened in order to thus supply power to the load terminal via the battery switch starting from the battery terminals. In principle, the load terminal can thus be connected to the battery terminal, or disconnected therefrom, in a switchable manner. In the same way, the load terminal can be connected to one side of the DC-DC converter, or disconnected therefrom, in a switchable manner. As a result, an on-board electrical system branch which is not burdened with a fault can be connected in a selective manner starting from the load terminal while another on-board electrical system branch which is burdened with a fault can be cut off. If there are no faults, a combined power flow can then be produced via the closed battery switch and disconnecting switch, for instance in order to balance batteries which are connected to the battery terminals (i.e. to partially or completely achieve balancing of the states of charge), or in order to sum power flows which lead to the load terminal. In the same way, a power flow coming from a load terminal can thus be guided in a suitable manner, i.e. led to one or more of the components of the connection circuit in a targeted manner, or else parts of the connection circuit can be cut off in a targeted manner.

Moreover, it is possible to cut off Cy capacitances from loads which are connected to the load terminals (for instance inverters or the like) in a targeted manner by way of the disconnecting switch or battery switch during a charging process so that the Cy capacitances of the components cut off in this way cannot have a detrimental effect on the (load) terminal and/or on networks connected thereto.

The connection circuit can further have a first load terminal and/or a second load terminal. One of the load terminals or preferably both can be electric drive terminals. In this case, the first load terminal can be connected to one side of the DC-DC converter, such as to the first side, where this connection is carried out a connection which may include one or both disconnecting switches. The first load terminal can therefore be connected to one pole of the first side of the DC-DC converter via a first disconnecting switch and be connected to the second pole of the converter directly or via a second disconnecting switch. These disconnecting switches correspond to the disconnecting switches described herein. For example, these disconnecting switches correspond to the disconnecting switches by way of which the connection point is connected to an associated pole of the associated side of the DC-DC converter. The second load terminal can also be connected to the second side of the DC-DC converter at all poles or at one pole in a disconnectable manner (i.e. via one or two disconnecting switches). The disconnecting switches can thus be used to disconnect the load connected to the relevant load terminal from the converter or from the relevant battery terminal, for instance in order to cut off Cy capacitances of the connected load from the battery terminals or from the DC-DC converter. In the case of disconnecting switches provided at all poles, i.e. one disconnecting switch per pole, the first load terminal can be connected to the first side of the DC-DC converter via disconnecting switches provided at all poles. The second load terminal can furthermore be connected to the second side of the DC-DC converter via disconnecting switches provided at all poles. Two disconnecting switches can therefore be provided on the first side of the DC-DC converter, which disconnecting switches connect the first side of the DC-DC converter to the first load terminal at all poles. Furthermore, two disconnecting switches which connect the second side of the DC-DC converter to the second load terminal may be provided.

The battery connection switches can have one or more additional load terminals (or further load terminals). Some implementations provide that the latter is connected in parallel with one of the load terminals. In some examples, the additional load terminals are connected to one of the two sides of the DC-DC converter via a separate disconnecting switch (“additional disconnecting switch”). In addition, in some examples, at least one additional load terminal is connected directly or via a separate disconnecting switch to one of the two sides of the DC-DC converter directly. As a result, the connection between the additional load terminal and the DC-DC converter can be established or disconnected individually by way of the additional disconnecting switch. In particular, the additional load terminal is connected to the DC-DC converter directly apart from the interposed additional disconnecting switch such that, when the additional disconnecting switch is closed and the disconnecting switches (which lead to a load terminal) are open, only the additional load terminal is connected to the converter but not the load terminal. Unless referred to otherwise, the term “disconnecting switch” refers to a disconnecting switch which connects the DC-DC converter to a load terminal in a switchable manner while the term “additional disconnecting switch” refers to a separate disconnecting switch which connects the additional load terminal to the DC-DC converter in a switchable manner. In particular, the additional disconnecting switch connects the additional load terminal to the DC-DC converter directly and not via one of the other disconnecting switches (which lead to the first or second load terminal). The additional disconnecting switch can be used to switch the connection of the additional load terminal independently of the connection of the first or second load terminal.

The battery connection circuit can further have an on-board charger. The latter may be connected to the first side of the DC-DC converter at all poles. In other words, the on-board charger is connected to the DC-DC converter. In an alternative example, the on-board charger is connected to the second side of the DC-DC converter, for example at all poles. The all-pole connection between the charger and the DC-DC converter can be direct here too, i.e. switch-free, or have at least one charging switch. The charger is either an AC charger having a rectifier or having a power factor correction filter, or is a DC charger which can be converter-free and e.g. including disconnecting switches or which has a charging DC-DC converter. If the charger is configured as an AC charger, the latter can thus also have a further charging DC-DC converter in addition to the rectifier in order to thus raise or lower the rectified voltage of the rectifier to a desired voltage level.

In some implementations, the battery connection switch has at least one low-voltage converter. The latter is set up to perform step-down conversion. The low-voltage converter can be configured, for example, to perform the step-down conversion of 400 V and 800 V to a low voltage of 12 V, 14 V, 24V or 48 V. The low-voltage converter is therefore a step-down converter. The at least one low-voltage converter may be connected to the first side or the second side of the DC-DC converter. In this case, the low-voltage converter can be connected to the DC-DC converter via at least one disconnecting switch, i.e. via a single-pole or via an all-pole disconnecting switch. For example, the low-voltage converter is connected to the DC-DC converter via the disconnecting switches which also connect one of the load terminals to the DC-DC converter. The low-voltage converter is in the form of a DC-DC converter but is referred to as a low-voltage converter here to avoid confusion.

The battery connection circuit can have a control device which is connected to the configuration circuit for controlling it. The control device is set up to control the configuration circuit to form the parallel connection of the battery terminals in a parallel state. The control device is further set up to control the configuration circuit to form the series connection of the battery terminals in a series state. Additionally, the control device can be set up to control the configuration circuit to not connect the battery terminals to one another in an individual supply state. In this state, the configuration circuit does not connect the battery terminals to one another (where connections via other elements of the circuit are possible, however). The control device is therefore connected to the configuration circuit for the purpose of controlling it. The configuration circuit is connected to the battery terminals directly in order to establish the desired configuration.

In some examples, the individual supply state can have a plurality of sub-states which can be referred to as individual supply states of first, second, ( . . . ) type. The control device can be set up, in a driving state, to set a first type of the individual supply state in which the control device controls the DC-DC converter to balance energy between the battery terminals. In this state, the DC-DC converter is active. The control device is therefore also (directly or indirectly) connected to the DC-DC converter for the purpose of controlling it. In particular, in the case of an active DC-DC converter, energy balancing takes place between the battery terminals and, for example, between the batteries which are connected to the battery terminals. The control device can have a further, second sub-state of the individual supply state. This can be referred to as the second type of the individual supply state or part fault state. This occurs in the event of a part fault state (of the connection circuit). In the part fault state (as a second type of the individual supply state), the control device can provide for the DC-DC converter to be deactivated or not operate the latter. In this state, the DC-DC converter is controlled by the control device in such a way that the DC-DC converter prevents energy balancing or a power flow between the battery terminals. The control device can be set up to detect the part fault state itself or has an input at which the existence of a part fault state is indicated by a signal.

In the part fault state, there are faults in individual components within the connection circuit and so by way of separation carried out by the DC-DC converter (DC-DC converter inactive) the components on one side of the DC-DC converter are separated from the components on the other side of the DC-DC converter. Since the configuration circuit is also open in this state, i.e. the battery terminals are not connected to one another, the DC-DC converter and the configuration circuit can thus provide complete separation (such as all-pole) of the two sub-networks of the connection circuit which are located on either side of the DC-DC converter. The control device is set up to control the DC-DC converter by a corresponding clock signal (in the inactive state without pulse, working switch open, in the active state clocked) or by way a corresponding operating state signal which indicates whether or not the DC-DC converter is to be operated in a clocked manner.

Moreover, in some examples, in an AC charging state, i.e. in an AC voltage state, the configuration circuit may be in a series state. The control device is set up to perform this. If the control device puts the DC-DC converter in an inactive mode during the AC charging state, the series connection of the two battery terminals is supplied with charging voltage. This voltage is divided among the battery terminals. The control device may be set up, in the AC charging state, to control the DC-DC converter to balance energy between the battery terminals or to transfer power between the battery terminals. As a result, compensating currents can flow between the battery terminals such that the states of charge of batteries which are connected to the battery terminals are balanced, for example while charging energy is led to both battery terminals. In this case, the control device is set up to control the DC-DC converter to assume the active DC-DC conversion if energy balancing or a power flow between the battery terminals is to take place. If energy balancing or a power flow takes place via the DC-DC converter, i.e. if the DC-DC converter is active, the latter is then controlled in a clocked manner by the control device in a known way. Furthermore, it is possible for the control device to also deliver only an activation signal to the DC-DC converter which itself has an internal controller which specifies the clocking. The control device can have an input to which a signal representing the state which is to be set is able to be applied. The control device is set up to set the state entered at the input.

Furthermore, a vehicle on-board electrical system which has a battery connection circuit as described herein is described. The vehicle on-board electrical system has a first and a second battery. The first battery is connected to a first battery terminal. The second battery is connected to the second battery terminal. The connection between the batteries and the respective battery terminals is preferably switch-free. The batteries may be in the form of high-voltage traction accumulators. The batteries therefore have a nominal voltage of more than 60 V, such as at least 200 V, for example at least 400 V, 600 V or 800 V. Moreover, the vehicle on-board electrical system has a first and a second electrical traction drive. The first traction drive is connected to the first battery. The second traction drive is connected to the second battery. In some examples, this is implemented in that the first traction drive is connected to the first load terminal and the second traction drive is connected to the second load terminal. The connection between traction terminal and battery may have switches, such as the disconnecting switches mentioned here or the battery switches mentioned here.

One pole of the traction drive can be connected to the battery, for example, to the battery terminal, via a battery switch, and another pole can be connected to the voltage converter via a disconnecting switch. In some examples, a further disconnecting switch which connects the first-mentioned pole of the first traction drive to the DC-DC converter is provided. Additionally, in some examples one of the traction drives, such as the second traction drive, is connected via an all-pole disconnecting switch to the DC-DC converter and/or be connected to the battery or to the battery terminal. For example, the traction drives are connected to the connection circuit via the load terminals. In this case, the first traction drive is connected to the first load terminal and the second traction drive is connected to the second load terminal.

The result of this is an all-pole connection between the traction drive and the first battery terminal via the connection circuit. Furthermore, the first traction drive can be connected to the first side of the DC-DC converter. The connection between traction drive on the one side and battery and converter on the other side can have an all-pole disconnecting switch. The connection between the second traction drive and the DC-DC converter can also have an all-pole disconnecting switch. Additionally, the connection between the second traction drive and the second battery or in the second battery terminal can have a disconnecting switch (in a first busbar) and a battery switch (in the second busbar). The disconnecting switch and the battery switch together form an all-pole switch.

The battery connection circuit described here can be provided for the parallel or series connection of the battery terminals, where this configuration is provided by the configuration circuit. In this case, the batteries can be charged in the corresponding desired connection. Alternatively, the batteries can carry out direct charge balancing in a parallel configuration. Moreover, in an individual supply state, the configuration circuit can provide no connection between the two sides of the DC-DC converter or between the battery terminals. In this case, the DC-DC converter can be active in order to allow charge balancing between the battery terminals in this way. This can then be controlled by the DC-DC converter.

Moreover, it is possible for the first supply terminal to be supplied with power only by the first battery terminal in the individual supply state. Additionally, in the individual supply state, there can be a connection of the second battery terminal only to the second load terminal and/or to the additional load terminal. The corresponding battery switch and disconnecting switch are accordingly equipped to provide this individual connection. Additionally, the one hand for the configuration circuit to be in the individual supply state if a fault occurs in a part of the connection circuit.

If a fault occurs at the additional load terminal or the second load terminal, at least one of the battery switch and disconnecting switch connected thereto can thus be opened so that the faulty component is cut off. In this case, the configuration circuit can be in the individual supply state or can be in the series or parallel configuration state in order to be able to supply power to the remaining components, for instance on the first side of the DC-DC converter, by way of both battery terminals. In this case, the battery switches or disconnecting switches to the first side of the DC-DC converter are closed in order to enable a power flow and in particular to allow a power flow to the first load terminal.

In the same way, the first load terminal can be separated from the first battery terminal or from the first side of the DC-DC converter, where the disconnecting switches or battery switches connected to the load terminal are open in this case. As a result, a faulty load at the first load terminal can be cut off. The switches to the second side of the DC-DC converter can be closed and a connection between the converter or the second battery terminal on one side and the second load terminal or the additional load terminal on the other side is thus made possible. In this case, the configuration circuit can also be in the individual supply state, or can be in the parallel or series configuration state, in order to make it possible for the second load terminal and/or the additional load terminal to be able to be supplied with power from both battery terminals or from the DC-DC converter.

If the additional load terminal is connected via a separate disconnecting switch, the latter can thus be closed while the switches (disconnecting switch and battery switch) leading to the second load terminal are open. As a result, the second load terminal can be cut off while a connection between the additional load terminal on the one side and the second battery terminal, the DC-DC converter and/or the first battery terminal is possible at the same time in order to thus be able to supply power to the additional load terminal.

In some examples, when feeding charging energy via the charging terminal or via the charger, the disconnecting switches leading to the first load terminal and to the second load terminal may be open. As a result, the situation in which parasitic Cy capacitances connected to the load terminals are transferred into the charger or into the connected external charging station is avoided. This is critical for chargers which are not electrically isolating. In this case, the charging terminal is connected to the first side of the DC-DC converter via the charger (in an electrically conductive manner) at one pole.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 shows a battery connection circuit within a vehicle on-board electrical system.

### DETAILED DESCRIPTION

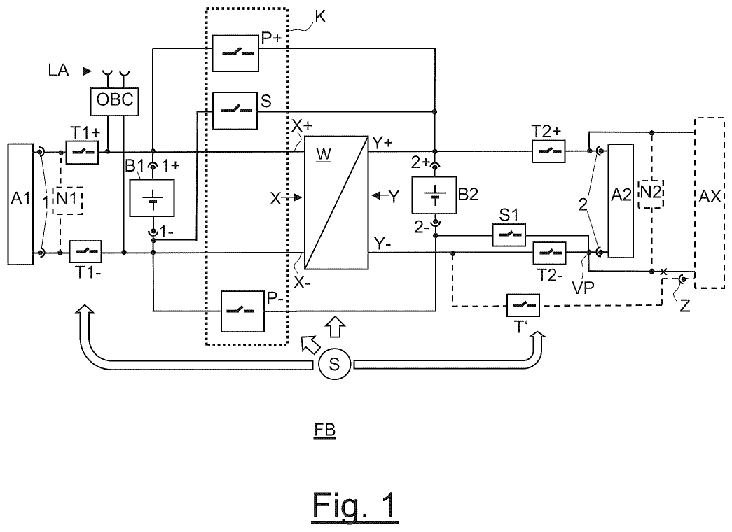

The battery connection circuit illustrated in FIG. 1 has two battery terminals which each have two poles 1+, 1− and 2+, 2−, respectively. The first battery terminal therefore has a two-pole design having the poles 1+, 1−. The second battery terminal likewise has a two-pole design having the poles 2+, 2−. The pole whose reference sign contains a plus (+) is the positive pole and can be referred to as the first pole. The other pole, whose reference sign contains a minus (−), can be referred to as the negative pole or second pole. The battery terminals are each in the form of high-voltage terminals having corresponding insulation, i.e. for operating voltages of more than 60 V, in particular of at least 200 V, 400 V, 600 V or 800 V.

A DC-DC converter W which has a first side X and a second side Y is illustrated. The first side X has a first pole X+ and a second pole X−. The second side Y has a first pole Y+ and a second pole Y−. Here too, the poles whose reference signs have a plus (+) are the positive poles and can be referred to as first poles. The poles whose reference signs have a minus (−) are the negative poles and can be referred to as second poles of the relevant side.

The first battery terminal having the poles 1−, 1+ is connected directly, i.e. switch-free, to the first side X of the DC-DC converter W, such as to poles X+, X− thereof. In this case, the first poles are connected to one another and the second poles are connected to one another. The second battery terminal having the poles 2−, 2+ is connected to the second side of the converter W. In this case, the first pole 2+ of the second battery terminal is connected directly, i.e. switch-free, to the first pole Y+ of the second side Y of the DC-DC converter W. The second pole 2− of the battery terminal is connected via a battery switch S1 to a disconnecting switch T2− which in turn leads directly (i.e. switch-free) to the second pole Y− of the second side Y of the DC-DC converter W. The second battery terminal is therefore connected to the DC-DC converter W not directly but via the switches S1 and T2− in the negative busbar, i.e. it is connected to the DC-DC converter W indirectly. Illustrated is the case in which only one pole 2− of the battery terminal 2+, 2−, namely the pole 2−, is connected to the DC-DC converter W via switches (battery switch S1, disconnecting switch T2−) while the other pole 2+ is connected directly to the DC-DC converter or to the second side Y. However, both battery poles may be connected to the relevant pole of the relevant side (here the second side Y) of the DC-DC converter W via at least one switch.

The alternative according to which the battery terminal is connected to the relevant side of the DC-DC converter switch-free, i.e. directly, is illustrated on the basis of the battery terminal having the poles 1+, 1− and the side X of the DC-DC converter W. However, this can also be implemented for the second side Y. In the same way, the single-pole or all-pole indirect connection (which leads via the battery switch and disconnecting switch) between the battery terminal and the DC-DC converter W can also be provided on the first side X. The designation “indirect connection” here means connection via at least one switch, in particular connection via a battery switch which leads to the relevant pole of the relevant side of the DC-DC converter W via a disconnecting switch.

This indirect connection has a connection point via which the battery switch and the disconnecting switch are connected to one another. In FIG. 1, this connection point is for the connection between the second pole 2− of the second battery terminal and the second pole Y− of the second side Y of the DC-DC converter W. However, this is only exemplary and can, as mentioned, also relate to other poles (Y+) or to the other side X (having the poles X+, X−) of the converter W.

A first load terminal 1 and a second load terminal 2 are also part of the illustrated battery connection circuit. The first load terminal 1 is located on the first side X of the DC-DC converter W and is connected to the first side X of the DC-DC converter W via an all-pole switch having the switching elements T1+, T1−. A first pole of the load terminal 1 is connected to the pole X+ of the converter W via the switching element T1+. A second pole (the negative pole) is connected to the negative pole X− of the first side of the DC-DC converter W via the switching element T1−. Both switching elements T1+, T1− are located in different busbars, i.e. in busbars of different polarity, such that together they form a switch device which can cut off the first load terminal 1 from the first side X of the DC-DC converter W at all poles.

A load terminal is also located on the second side Y of the DC-DC converter W, namely the second load terminal 2. This is connected to the DC-DC converter W in the same way: an all-pole switch device having the switching elements T2−, T2+ connects the second load terminal 2 to the second side Y, i.e. to the poles Y+, Y− of the second side of the DC-DC converter W. It is noted that the switching element T2− in this case is identical to the disconnecting switch which was mentioned previously. That means that one pole of the second load terminal 2 is connected to the second side Y of the DC-DC converter W via the disconnecting switch T2− via which the battery switch S1 is also connected to the DC-DC converter (W). This battery switch S1 connects the second battery terminal or its pole 2− to the disconnecting switch T2− or to the connection point VP. In accordance with the preceding examples, this can also be provided for the other pole, where the other pole of the second load terminal 2 can in this case also be connected to the DC-DC converter via a disconnecting switch, to which a battery switch leading to the other pole of the battery terminal is connected. In an example which is not illustrated, both poles of the second (or first) load terminal can therefore be connected to the DC-DC converter in this way, as is illustrated for the lower pole of the second load terminal 2 in FIG. 1.

The battery connection circuit further includes a configuration circuit K via which the two battery terminals are connected to one another in a configurable manner. For this purpose, the configuration circuit includes a series switch S which is closed when the two battery terminals are connected to one another in series. In this case, the series switch S connects a first pole 2+ of the first battery terminal to a second pole 1− of the second battery terminal. Generally, the mentioned poles which are connected in a switchable manner by the series switch S have different polarities. In the example illustrated, the series switch S in the closed state connects the negative pole 1− of the first battery terminal to the positive pole 2+ of the second battery terminal.

The configuration circuit is further equipped with two parallel switches P−, P+. These are assigned to different polarities. The switches P−, P+ are actuated at the same time and can therefore also be switching elements of a mutual switch device. If the switches P+, P− are closed, the first and the second battery terminal are then connected to one another in parallel. In this case, the parallel switches P−, P+ connect the first pole of the first battery terminal 1+ to the first pole 2+ of the second battery terminal and additionally connect, separated therefrom, the second pole 1− of the first battery terminal to the second pole 2− of the second battery terminal. In a simplified embodiment, the series switch S is replaced by a diode. Additionally, if two parallel switches P+, P− and one series switch S are used, as illustrated, the series switch S is then open when the parallel switches are closed and the parallel switches are open when the series switch is open. The switches S, P+ and P− can also be open at the same time, for instance in an individual supply state.

A control device S which controls the configuration circuit K is provided, as illustrated by the double arrow. This control device S is configured to connect the battery terminals to one another in series in a series state by closing the switch S and is set up to connect the two battery terminals to one another in parallel in a parallel state via the parallel switches P+, P−. In an individual supply state, all of the switches P+, P−, S are open and so the two battery terminals are not connected to one another. The individual supply state can involve an active converter W or involve an inactive converter W which then separates the first side X and the second side Y from one another or via which no electrical connection between the sides X, Y is provided. The control device S can be provided to also control the converter W (cf. double arrow) and in order to put the latter in an active state or selectively in an inactive state. In the active state, the DC-DC converter W is set up to transfer power from one side X to the other Y. The DC-DC converter W is configured to be bidirectional so that either the mentioned power transfer direction is provided or the reverse direction is provided in a selectable manner. The DC-DC converter W can also be designed to be unidirectional, such as if the loads are distributed accordingly in the system or if by way of suitable control the load/the power flows become compatible.

The battery connection circuit can further have a charger OBC. This is connected to the first battery terminal directly, i.e. switch-free. The charger OBC connects a charging terminal LA of the battery connection circuit to the first battery terminal 1+, 1−. For example, the charger is connected to the first battery terminal directly, i.e. not via the disconnecting switches T1+, T1−. In some examples, the charger is connected to the first battery terminal via disconnecting switches such as the disconnecting switches T1+, T1− such that the first load terminal and the charger are connected on the same side of the disconnecting switches. However, in FIG. 1 illustrated, the first load terminal and the charger are connected on different sides of the all-pole disconnecting switch having the switching elements T1+, T1−. In FIG. 1, the charger is by way of example connected on the first side X of the converter W, such as to those disconnecting switches T1+, T1− which are connected to the first battery terminal 1+, 1−.

The connection circuit illustrated is further illustrated having a first low-voltage converter N1. This is optional and therefore illustrated by a dashed line. The first low-voltage converter is connected directly to the first load terminal, i.e. on the first side of the disconnecting switches T1+, T1− which is the far side with respect to the first battery terminal 1−, 1+. In an alternative example, the first low-voltage converter can be connected directly to the first battery terminal or is connected directly, i.e. switch-free, to the first side X of the DC-DC converter W.

Furthermore, in FIG. 1, in some examples, a second (optional) low-voltage converter which can be provided as an alternative to or in combination with the first low-voltage converter. This is also illustrated by a dashed line in order to thus signify that it is an optional component. The connection of the second low-voltage converter N2 to the second side Y of the DC-DC converter W via the disconnecting switch elements T2+, T2− of an all-pole disconnecting switch which also connects the second load terminal 2 to the second side Y of the DC-DC converter W is illustrated by solid lines. It is noted that the second DC-DC converter N2 is thus also connected to the second battery terminal, namely on the one hand via the disconnecting switch T2+(in the upper busbar) and via the battery switch S1 which leads from the second load terminal or from the connection point VP to the second battery terminal.

The battery connection circuit can therefore have a first and/or second low-voltage converter N1, N2, where in the case of two low-voltage converters both are provided on different sides X, Y or are connected to different battery terminals (1+, 1− compared to 2+, 2−). Just like the load terminal (1 or 2), the respective low-voltage converter (N1 or N2) is connected via at least one switch (disconnecting switch or battery switch) to the DC-DC converter or to one of the battery terminals. However, a low-voltage converter may be connected to a battery terminal directly even if the low-voltage converter is connected to the converter in an indirect way via a battery switch and a disconnecting switch.

FIG. 1 further shows an additional load terminal Z. This is an alternative feature and therefore illustrated by a dashed line. The additional load terminal Z is either connected directly to one pole of one side of the converter W, i.e. to one of the poles X+, X−, Y+, Y−, or is connected to one of the mentioned poles of the disconnecting switch via a separate disconnecting switch T′ which can also be referred to as an additional disconnecting switch. The separate disconnecting switch T′ is therefore optional. One example in which the additional load terminal Z is connected to pole Y−, i.e. to the second pole of the second side Y of the DC-DC converter W, via a separate disconnecting switch T′ is illustrated. The separate disconnecting switch T′ therefore connects the second pole Y− of the side Y of the DC-DC converter W to the additional load terminal in a direct way. The separate disconnecting switch T′ of the additional load terminal Z can thus be used to cut off or connect an additional load in a targeted manner.

The control device S is further connected to the switches mentioned here, for example to the disconnecting switches and the battery switches which are illustrated, for the purpose of controlling them.

Alongside the battery connection circuit, FIG. 1 shows a first load A1 (connected to terminal 1) in the form of a first electric drive and a second load A2 (connected to terminal 2) in the form of a second electric drive. Both drives are traction drives of the same vehicle and are in particular arranged on different axles.

If the configuration circuit K is in an individual supply state, the battery B1 which is connected to the first battery terminal then supplies power to the first drive A1 and the battery B2 which is connected to the second battery terminal supplies power to the drive A2. In this case, the converter can be controlled to be inactive or active, for instance in order to balance different states of charge of the batteries B1 and B2. Furthermore, the converter can be provided to transfer power from one side to the other side, i.e. between sides X and Y, in order to thus for example transfer power from a battery to the drive of the other side, as a result of which both batteries B1 and B2 supply power to the same drive. This can be carried out, for example, if only one drive is desired or if one drive is defective. If one drive is defective, it can be cut off by way of the relevant disconnecting switches. The first drive A1 can thus be cut off, for example, by way of the disconnecting switches T1− and T1+. The second drive A2 can be cut off by way of the disconnecting switches T2−, T2+. The controller is set up, in the corresponding fault states which indicate faults in the relevant drives, to cut off these drives.

This cutting off is also possible if another connected load, for instance the load AX as an additional load (for instance a heater or an air-conditioning system), is to be made inactive.

Moreover, it is possible, for instance when charging or feeding back, to provide the configuration circuit in the series state or in the parallel state. In the series state, said configuration circuit connects the batteries B1 and B2 in series. In this case, a charging voltage of 800 V for example can then be provided via the charging terminal LA while the batteries are charged with a corresponding split voltage of 400 V, i.e. with half of said charging voltage. Additionally, when parallel switches P+, P− are closed, the batteries B1 and B2 can be connected in parallel. As a result, both batteries can be charged at the same time via the charger OBC. This can be provided, for example, by way of a DC voltage of 400 V which is applied wholly to the first battery B1 and wholly to the second battery B2. In this case, the charger can have only disconnecting switches or other safety mechanisms, or can have a DC-DC converter. Alternatively, the charger can be designed for AC charging and have a rectifier. The charging voltage described here relates to the voltage which the charger applies to the first battery terminal.

In FIG. 1, an additional load AX is illustrated. This can be connected to the rest of the circuit via a switch which is not illustrated, wherein this switch can be located at the position denoted by the cross. As a result, the load AX can be cut off but while the load A2 or optionally also the low-voltage converter N2 for example can be supplied with voltage from one of the battery terminals or from the converter W. The terminal Z or the load AX is connected to the converter W (and in particular to the first pole 2+ of the second battery terminal) via the disconnecting switch T2+ and can be further connected to the converter via the separate disconnecting switch T′ (illustrated by a dashed line).

The illustrated control device S can therefore be connected to the configuration circuit K for the purpose of controlling it in order to selectively establish a series state, a parallel state or an individual supply state. In addition, the control device S can be connected to the DC-DC converter for the purpose of controlling it in order to provide the latter in an active state or to provide the latter in an active state. For example, if the control device controls the configuration circuit K in the series or parallel mode, the converter is brought into the active state by the control device. If the control device S controls the configuration circuit K in the individual supply state, the control device can then control the converter to assume an active or an inactive state. If faults occur on components of the illustrated connection circuit or in components which are connected thereto, the control device can then open the corresponding disconnecting switches at all poles or at one pole. As a result, faulty components can be cut off in order to thus avoid the situation in which faults have detrimental effects on the operation of further sections of the vehicle on-board electrical system or of the connection circuit.

In some implementations, the control device S may also be connected to the charger OBC for the purpose of controlling it. The control device S can be set up to provide the charger likewise in a floating state or inactive state or in an active state in which the charger transfers power from the charging terminal LA either unconverted, DC-converted, or rectified (and optionally rectified and DC-converted). The charger can also be bidirectional in order to thus for example feed power back via the charging terminal LA. In this case, energy is then output from the charging terminal LA. In a charging state, the control device S preferably controls the disconnecting switches T1+, T1− or T2+, T2− in an open state in order to thus avoid the situation in which Cy capacitances of the drives A1, A2 have detrimental effects on the charging terminal LA.

A number of implementations have been described. Nevertheless, it will be understood that various modifications may be made without departing from the spirit and scope of the disclosure. Accordingly, other implementations are within the scope of the following claims.

What is claimed is:

1. A battery connection circuit comprising:
a first battery terminal;
a second battery terminal;
a first load terminal;
a second load terminal,
a configuration circuit; and
a DC-DC converter having:
a first side connected to the first battery terminal, and
a second side connected to the second battery terminal, wherein the DC-DC converter performs DC-DC conversion between the sides,
wherein the first load terminal is connected to the first side and the second load terminal is connected to the second side, and
wherein the configuration circuit is connected to the battery terminals and is set up to selectively provide a series state or a parallel state, the configuration circuit selectively connects the battery terminals to one another:
in series in the series state, or
in parallel in the parallel state.

2. The battery connection circuit of claim 1, wherein the configuration circuit selectively provides the series state, the parallel state, or an individual supply state, wherein the configuration circuit selectively connects the battery terminals to one another:
in series in the series state,
in parallel in the parallel state, or
does not connect the battery terminals to one another in the individual supply state.

3. The battery connection circuit of claim 1, wherein the battery terminals have poles which are:
connected directly to an associated pole of an associated side of the DC-DC converter, or
connected via a battery switch to a connection point which is in turn connected to an associated pole of an associated side of the DC-DC converter via a disconnecting switch.

4. The battery connection circuit of claim 1, wherein:
the first load terminal is connected to the first side of the DC-DC converter via disconnecting switches provided at all poles, and
the second load terminal is connected to the second side of the DC-DC converter via disconnecting switches provided at all poles.

5. The battery connection circuit of claim 1, further comprising an additional load terminal connected to one of the two sides of the DC-DC converter via a separate disconnecting switch.

6. The battery connection circuit of claim 1, further comprising an on-board charger (OBC) connected to the first side of the DC-DC converter at all poles.

7. The battery connection circuit of claim 1, wherein further comprising at least one low-voltage converter which is set up to perform step-down conversion, wherein the at least one low-voltage converter is connected to the first side or to the second side of the DC-DC converter via disconnecting switches provided at all poles.

8. The battery connection circuit of claim 1, wherein further comprising a control device which is connected to the configuration circuit, the control device controlling the configuration circuit wherein the control device is configured to:
control the configuration circuit to form the parallel connection of the battery terminals in a parallel state,
control the configuration circuit to form the series connection of the battery terminals in a series state, and
control the configuration circuit to not connect the battery terminals to one another in an individual supply state.

9. The battery connection circuit of claim 8, wherein:
in a driving state, the control device sets a first type of the individual supply state in which the control device controls the DC-DC converter to balance energy between the batteries B1, B2 connected to the battery terminals, and
in a part fault state, the control device sets a second type of the individual supply state in which the control device deactivates the DC-DC converter and thus prevents energy balancing between the battery terminals.

10. The battery connection circuit of claim 8, wherein:
in an AC charging state, the control device controls the configuration circuit in a series state and controls the DC-DC converter to balance energy between the batteries connected to the battery terminals in order to charge the batteries in a balanced manner.

11. A vehicle on-board electrical system comprising:
a battery connection circuit comprising:
a first battery terminal;
a second battery terminal;
a first load terminal;
a second load terminal,
a configuration circuit; and
a DC-DC converter having:
a first side connected to the first battery terminal, and
a second side connected to the second battery terminal, the DC-DC converter performs DC-DC conversion between the sides,
wherein the first load terminal is connected to the first side and the second load terminal is connected to the second side, and
wherein the configuration circuit is connected to the battery terminals and is set up to selectively provide a series state or a parallel state, the configuration circuit selectively connects the battery terminals to one another:
in series in the series state, or
in parallel in the parallel state;
a first battery;
a second battery, the first battery is connected to the first battery terminal and the second battery is connected to the second battery terminal, the first and second batteries are in the form of high-voltage traction accumulators;
a first electrical traction drive; and
a second electrical traction drive, the first traction drive is connected to the first battery and the second traction drive is connected to the first battery.
